(19) United States
(12) Patent Application Publication
(10) Pub. No.: US 2026/0269975 A1
(43) Pub. Date: Sep. 10, 2026

(54) LTF SEQUENCE DESIGN FOR DISTRIBUTED-TONE RU ON WIDER BANDWIDTHS IN WIRELESS COMMUNICATIONS

(71) Applicant: MEDIATEK INC., Hsinchu City (TW)

(72) Inventors: Shengquan HU, San Jose, CA (US); Jianhan LIU, San Jose, CA (US); Thomas Edward PARE, Jr., San Jose, CA (US)

(21) Appl. No.: 19/166,269

(22) PCT Filed: Jun. 26, 2024
(86) PCT No.: PCT/CN2024/101560

§ 371 Date: Sep. 17, 2025

Related U.S. Application Data
(60) Provisional application No. 63/510,154, filed on Jun. 26, 2023.

(51) Int. Cl. H04L 1/00; H04L 5/00; H04W 84/12

(52) U.S. Cl. CPC H04L 1/0033; H04L 5/0053; H04W 84/12

(57) ABSTRACT

Various schemes pertaining to long-training field (LTF) sequence design for distributed-tone resource units (DRUs) on wider bandwidths in wireless communications are described. An apparatus (e.g., station (STA)) generates an LTF sequence of a DRU using a predefined DRU LTF base sequence. The apparatus transmits the DRU LTF sequence in a wireless communication for an DRU over a bandwidth of 160 MHz or wider.

### CROSS REFERENCE TO RELATED PATENT APPLICATION

The present disclosure is part of a non-provisional patent application claiming the priority benefit of U.S. Provisional Patent Application No. 63/510,154, filed 26 Jun. 2023, the content of which being incorporated by reference in its entirety.

### TECHNICAL FIELD

The present disclosure is generally related to wireless communications and, more particularly, to techniques pertaining to long-training field (LTF) sequence design for distributed-tone resource units (DRUs) on wider bandwidths in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area networks (WLANs) in accordance with one or more Institute of Electrical and Electronics Engineers (IEEE) 802.11 standards, the use of DRUs has been proposed to boost transmission power for 6 GHz low-power indoor (LPI) systems. Other than distributing tones on 20 MHz, 40 MHz and 80 MHz bandwidths, significant power boost gains may be achieved by distributing tones over wider bandwidths such as 160 MHz and 320 MHz. At the time of the present invention, how to generate and transmit long-training field (LTF) sequences based on an 80 MHz DRU tone plan has yet to be defined or specified. Therefore, there is a need for a solution of LTF sequence design for DRUs on wider bandwidths in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to LTF sequence design for DRUs on wider bandwidths in wireless communications. Under various proposed schemes described herein, an 80 MHz DRU tone plan may be utilized as a basic building block in the designs of DRU tone plans for wider bandwidths such as 160 MHz and 320 MHz, and LTF sequence generation and transmission may be carried out based on an 80 MHz DRU LTF sequence. It is believed that implementations of the proposed schemes may address or otherwise alleviate aforementioned issues.

In one aspect, a method may involve generating an LTF of a DRU using a predefined LTF base sequence. The method may also involve transmitting the LTF sequence in a wireless communication with DRU over a bandwidth of 160 MHz or wider.

In another aspect, an apparatus may include a transceiver and a processor coupled to the transceiver. The transceiver may be configured to transmit and receive wirelessly. The processor may be configured to generate an LTF of a DRU using a predefined LTF base sequence. The processor may also transmit the LTF sequence in a wireless communication with DRU over a bandwidth of 160 MHz or wider.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example scenario in accordance with an implementation of the present disclosure.

FIG. 8 is a diagram of an example scenario in accordance with an implementation of the present disclosure.

FIG. 9 is a diagram of an example scenario in accordance with an implementation of the present disclosure.

FIG. 10 is a diagram of an example scenario in accordance with an implementation of the present disclosure.

FIG. 11 is a diagram of an example scenario in accordance with an implementation of the present disclosure.

FIG. 12 is a diagram of an example design under a proposed scheme in accordance with the present disclosure.

FIG. 13 is a diagram of an example scenario in accordance with an implementation of the present disclosure.

FIG. 14 is a diagram of an example design under a proposed scheme in accordance with the present disclosure.

FIG. 15 is a block diagram of an example communication system under a proposed scheme in accordance with the present disclosure.

FIG. 16 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to LTF sequence design for DRUs on wider bandwidths in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (RRU) refers to a RU with tones that are continuous (e.g., immediately adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, an aggregate (26+52)-tone regular multi-RU (MRU) may be interchangeably denoted as MRU78 (or RMRU78), an aggregate (26+106)-tone regular MRU may be interchangeably denoted as MRU132 (or RMRU132), and so on. Furthermore, a distributed-tone RU (DRU) refers to a RU with tones that are non-discontinuous (e.g., not immediately adjacent to one another) and interleaved, interlaced or otherwise distributed. Accordingly, a 26-tone distributed-tone RU may be interchangeably denoted as DRU26, a 52-tone distributed-tone RU may be interchangeably denoted as DRU52, a 106-tone distributed-tone RU may be interchangeably denoted as DRU106, a 242-tone distributed-tone RU may be interchangeably denoted as DRU242, a 484-tone distributed-tone RU may be interchangeably denoted as DRU484, a 996-tone distributed-tone RU may be interchangeably denoted as DRU996, a 2×996-tone distributed-tone RU may be interchangeably denoted as DRU2×996, and so on.

It is also noteworthy that, in the present disclosure, a bandwidth of 20 MHz may be interchangeably denoted as BW20 or BW20 M, a bandwidth of 40 MHz may be interchangeably denoted as BW40 or BW40 M, a bandwidth of 80 MHz may be interchangeably denoted as BW80 or BW80 M, a bandwidth of 160 MHz may be interchangeably denoted as BW160 or BW160 M, a bandwidth of 240 MHz may be interchangeably denoted as BW240 or BW240 M, a bandwidth of 320 MHz may be interchangeably denoted as BW320 or BW320 M, a bandwidth of 480 MHz may be interchangeably denoted as BW480 or BW480 M, a bandwidth of 500 MHz may be interchangeably denoted as BW500 or BW500 M, a bandwidth of 520 MHz may be interchangeably denoted as BW520 or BW520 M, a bandwidth of 540 MHz may be interchangeably denoted as BW540 or BW540 M, a bandwidth of 640 MHz may be interchangeably denoted as BW640 or BW640 M.

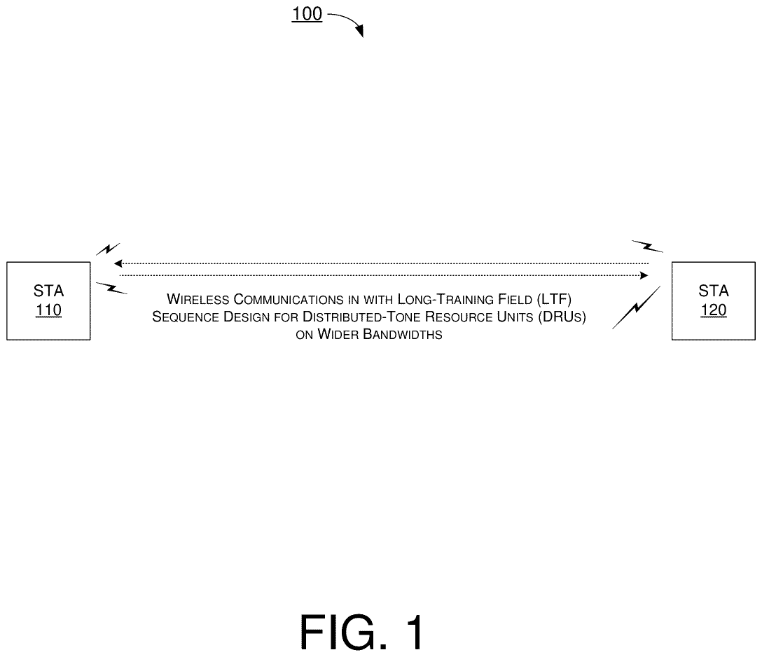

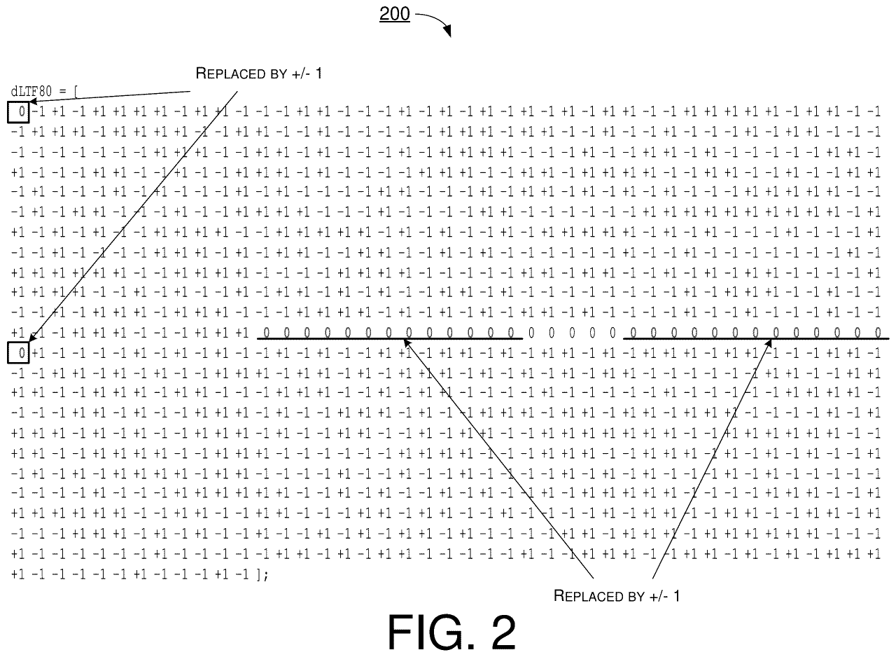

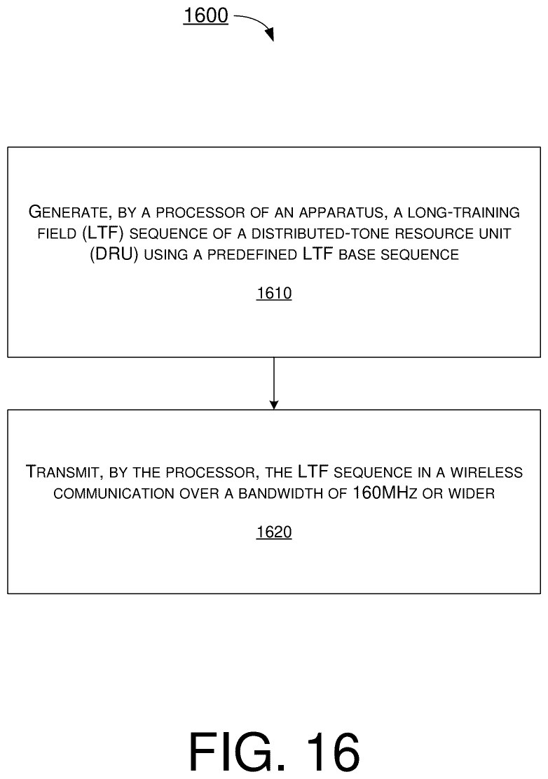

FIG. 1 illustrates an example network environment 100 in which various solutions and schemes in accordance with the present disclosure may be implemented. FIG. 2~FIG. 16 illustrate examples of implementation of various proposed schemes in network environment 100 in accordance with the present disclosure. The following description of various proposed schemes is provided with reference to FIG. 1~FIG. 16.

Referring to FIG. 1, network environment 100 may involve at least a station (STA) 110 communicating wirelessly with a STA 120. Either of STA 110 and STA 120 may function as an access point (AP) STA or, alternatively, a non-AP STA. In some cases, STA 110 and STA 120 may be associated with a basic service set (BSS) in accordance with one or more IEEE 802.11 standards (e.g., IEEE 802.11be and/or future-developed standards such as IEEE 802.11bn). Each of STA 110 and STA 120 may be configured to communicate with each other by utilizing the LTF sequence design for DRUs on wider bandwidths in wireless communications in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example design 200 under a proposed scheme in accordance with the present disclosure. Under the proposed scheme, an LTF sequence for 80 MHz DRUs (e.g., an IEEE 802.11bn 80 MHz subblock base sequence) may be utilized in the design of DRU LTF sequence for wider bandwidths. For instance, an LTF sequence for 80 MHz DRUs, as a base sequence (herein denoted as “dLTF80”), may be modified and utilized for wider bandwidths such as 160 MHz and 320 MHz, among other wider bandwidths. Referring to FIG. 2, under the proposed scheme, certain tones with a value of “0” in the LTF sequence for 80 MHz DRUs may be replaced by “+1” or “−1” in generating an LTF sequence for DRUs over wider bandwidths.

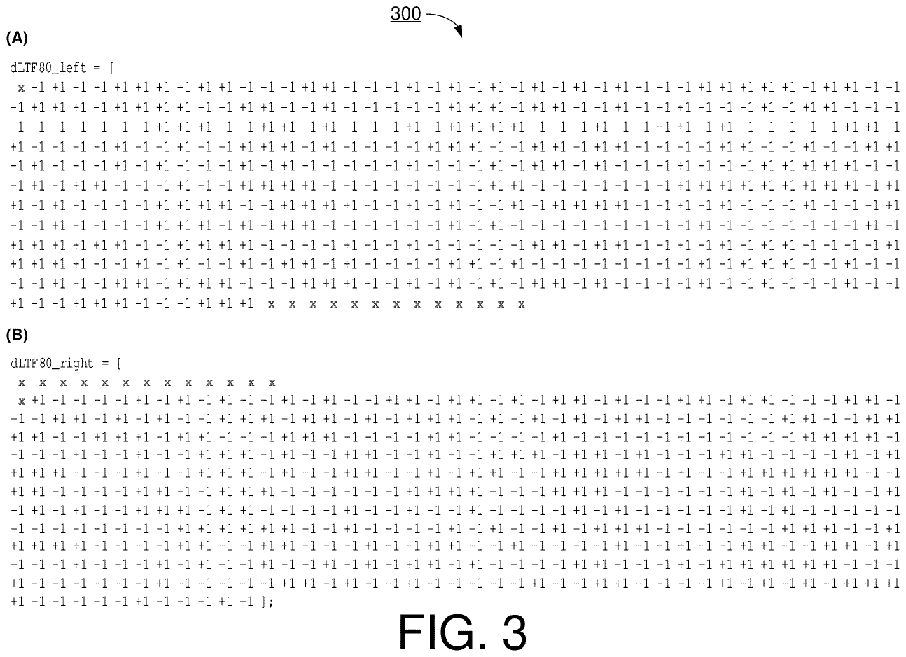

FIG. 3 illustrates an example design 300 under a proposed scheme in accordance with the present disclosure. Under the proposed scheme, the LTF base sequence for 80 MHz DRUs may be considered as comprising a left half of the LTF base sequence and a right half of the LTF base sequence, as shown in FIG. 3. Accordingly, the left half of an IEEE 802.11bn 80 MHz subblock LTF base sequence may herein be denoted as “dLTF80_left” and the right half of the IEEE 802.11bn 80 MHz subblock LTF base sequence may herein be denoted as “dLTF80_right.” In terms of tone indices, dLTF80_left=dLTF80 (1:498) and dLTF80_right=dLTF (499:996). In FIG. 3, the positions marked with “x” may be replaced by +/−1 and may be optimized to minimize or otherwise reduce peak-to-average power ratio (PAPR).

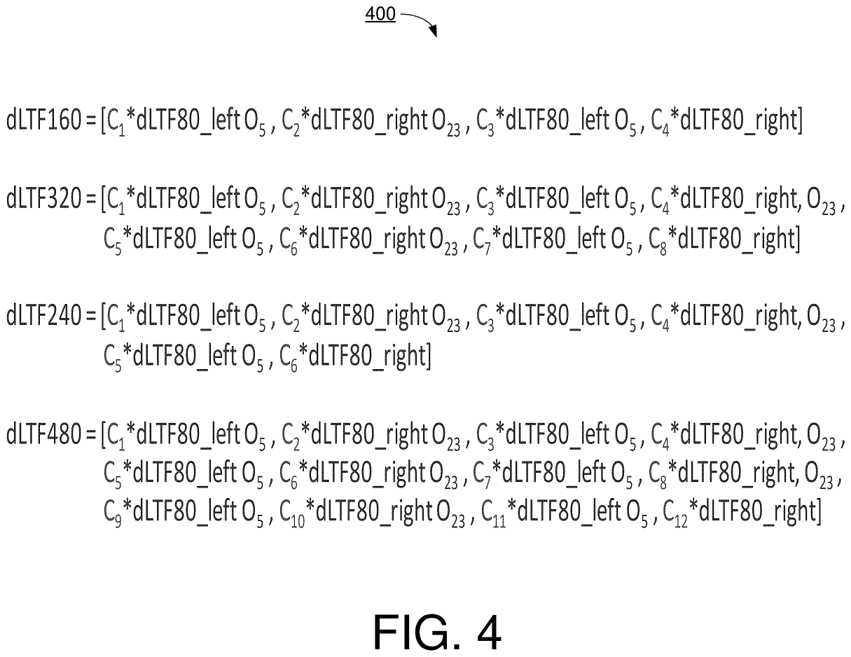

FIG. 4 illustrates an example design 400 under a proposed scheme in accordance with the present disclosure. Under the proposed scheme, with respect to general consideration of DRU LTF sequence design for wider bandwidths, a fundamental idea is to use the base sequence of dLTF80_left and dLTF80_right as the basic building blocks. For instance, a DRU LTF sequence for wider bandwidths may be constructed as one of the combinations shown in FIG. 4. The combination coefficients C₁, C₂, C₃, C₄, C₅, C₆, C₇, C₈, C₉, C₁₀, C₁₁ and C₁₂ may be optimized via searching to minimize the PAPR over all the DRU sizes. For instance, the DRU LTF sequence for 160 MHz (herein denoted as “dLTF160”) may be expressed as dLTF160=[C₁*dLTF80_left O₅, C₂*dLTF80_right O₂₃, C₃*dLTF80_left O₅, C₄*dLTF80_right]. Additionally, the DRU LTF sequence for 320 MHz (herein denoted as “dLTF320”) may be expressed as dLTF320=[C₁*dLTF80_left O₅, C₂*dLTF80_right O₂₃, C₃*dLTF80_left O₅, C₄*dLTF80_right O23, C₅*dLTF80_left O₅, C₆*dLTF80_right O₂₃, C₇*dLTF80_left O₅, C₈*dLTF80_right]. Moreover, the DRU LTF sequence for 240 MHz (herein denoted as “dLTF240”) may be expressed as dLTF240=[C₁*dLTF80_left O₅, C₂*dLTF80_right O₂₃, C₃*dLTF80_left O₅, C₄*dLTF80_right O23, C₅*dLTF80_left O₅, C₆*dLTF80_right]. Furthermore, the DRU LTF sequence for 480 MHz (herein denoted as “dLTF480”) may be expressed as dLTF480=[C₁*dLTF80_left O₅, C₂*dLTF80_right O₂₃, C₃*dLTF80_left O₅, C₄*dLTF80_right, O23, C₅*dLTF80_left O₅, C₆*dLTF80_right O₂₃, C₇*dLTF80_left O₅, C₈*dLTF80_right O23, C₉*dLTF80_left O₅, C₁₀*dLTF80_right O₂₃, C₁₁*dLTF80_left O₅, C₁₂*dLTF80_right]. Here, the value of each of the optimized coefficients C₁, C₂, C₃, C₄, C₅, C₆, C₇, C₈, C₉, C₁₀, C₁₁ and C₁₂ may be −1 or +1. Moreover, in the above expressions, “0₅” denotes five consecutive 0s, and “0₂₃” denotes twenty-three consecutive 0s. The optimized coefficients may be chosen to achieve the minimum PAPR of LTF and data tones over all DRU types/sizes over a wider bandwidth (e.g., 160 MHz, 240 MHz, 320 MHz or 480 MHz) under the proposed scheme.

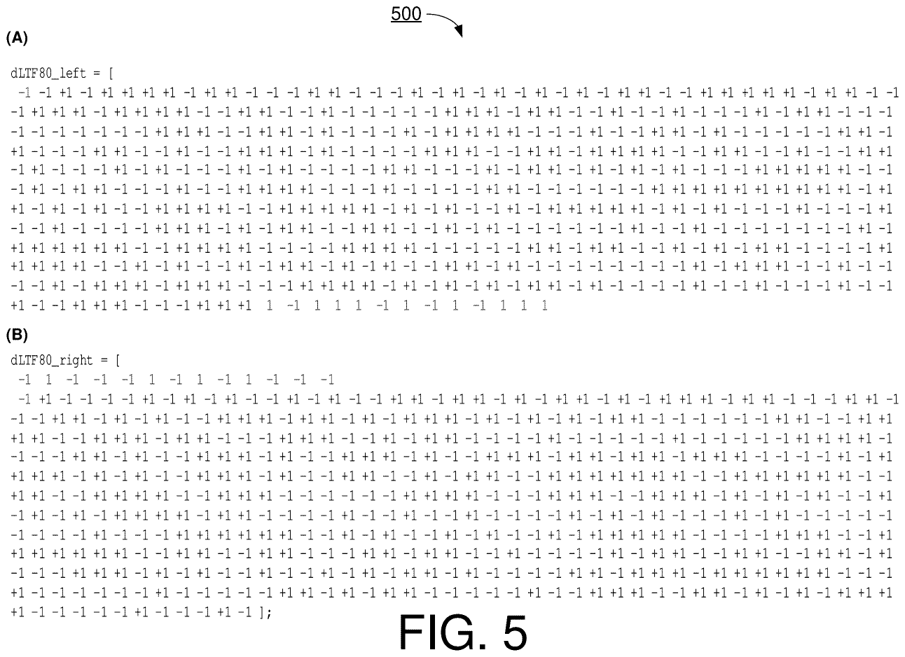

FIG. 5 illustrates an example design 500 under a proposed scheme in accordance with the present disclosure. Design 500 may pertain to a DRU LTF sequence design for wider bandwidths under a first option (Option-1). As shown in FIG. 5, each of the positions marked with “x” in FIG. 3 is replaced by +/−1 as a result of searching to minimize PAPR.

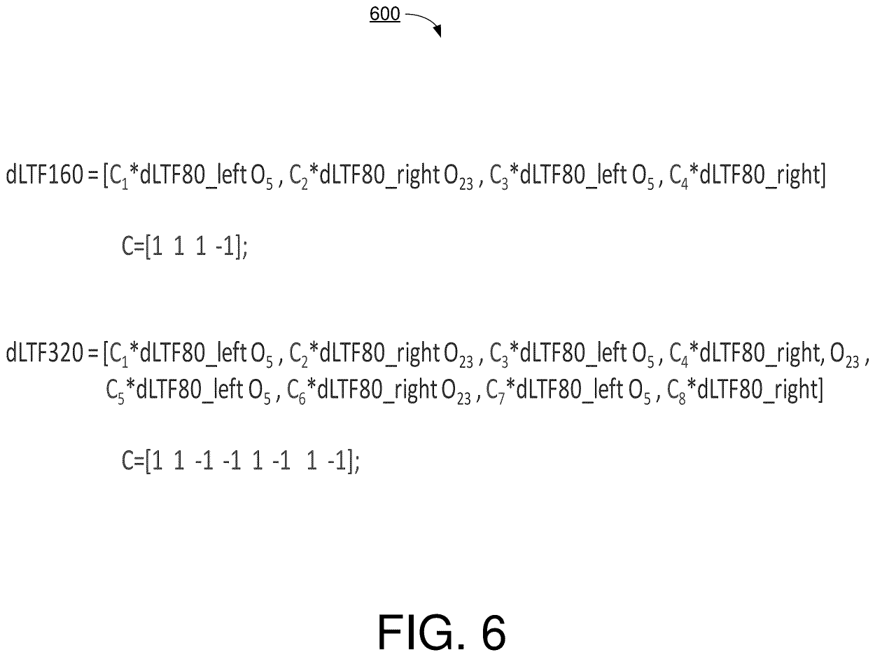

FIG. 6 illustrates an example design 600 under a proposed scheme in accordance with the present disclosure. Under the proposed scheme, dLTF160=[C₁*dLTF80_left O₅, C₂*dLTF80_right O₂₃, C₃*dLTF80_left O₅, C₄*dLTF80_right], with C=[C₁ C₂ C₃ C₄]=[1 1 1 −1]. Moreover, under the proposed scheme, dLTF320=[C₁*dLTF80_left O₅, C₂*dLTF80_right O₂₃, C₃*dLTF80_left O₅, C₄*dLTF80_right O23, C₅*dLTF80_left O₅, C₆*dLTF80_right O₂₃, C₇*dLTF80_left O₅, C₈*dLTF80_right], with C=[C₁ C₂ C₃ C₄ C₅ C₆ C₇ C₈]=[1 1 −1 −1 1 −1 −1]. Here, the vector C may comprise a combination of optimized coefficients, “0₅” denotes five consecutive 0s, and “0₂₃” denotes twenty-three consecutive 0s.

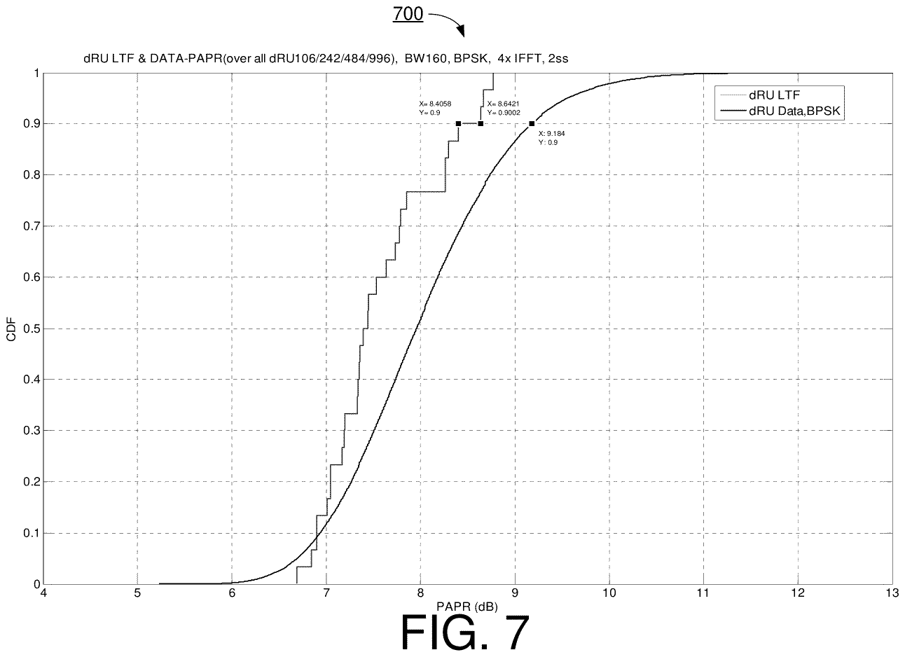

FIG. 7 illustrates an example scenario 700 in accordance with an implementation of the present disclosure. Scenario 700 may pertain to PAPR performance for DRU LTF for the wider bandwidth of 160 MHz.

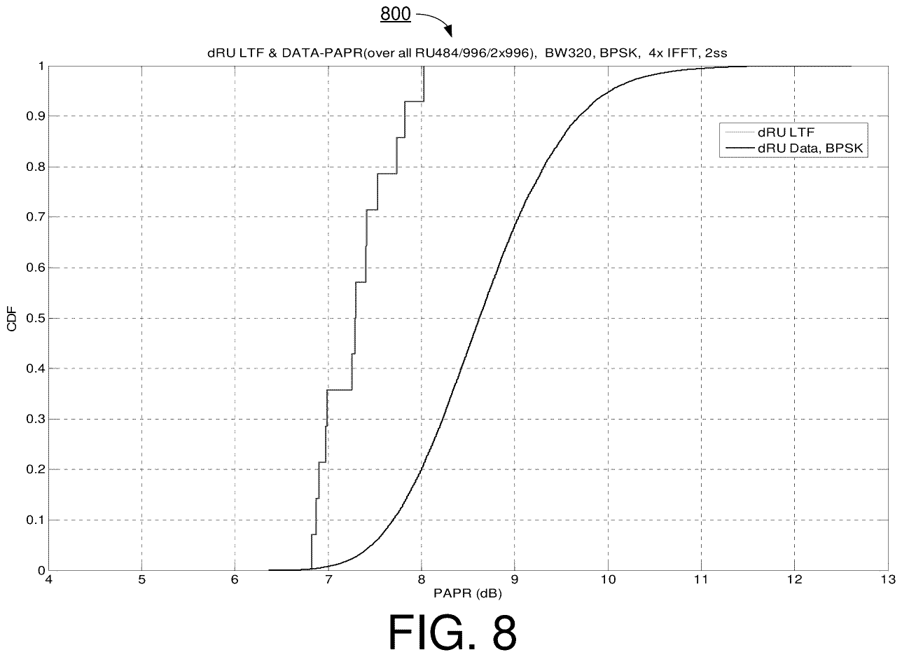

FIG. 8 illustrates an example scenario 800 in accordance with an implementation of the present disclosure. Scenario 800 may pertain to PAPR performance for DRU LTF for the wider bandwidth of 320 MHz.

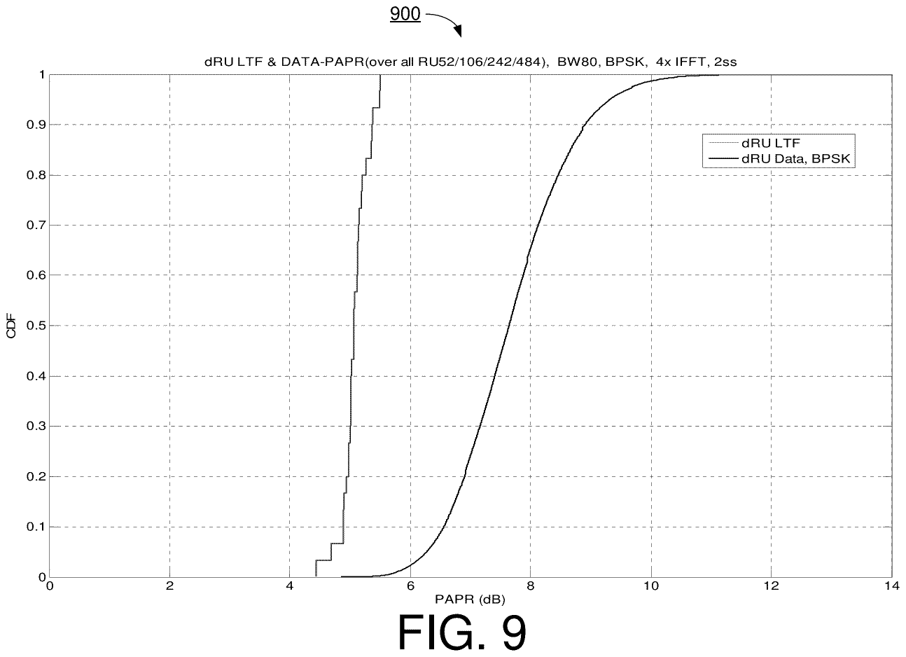

FIG. 9 illustrates an example scenario 900 in accordance with an implementation of the present disclosure. Scenario 900 may pertain to PAPR performance for DRU LTF for the bandwidth of 80 MHz.

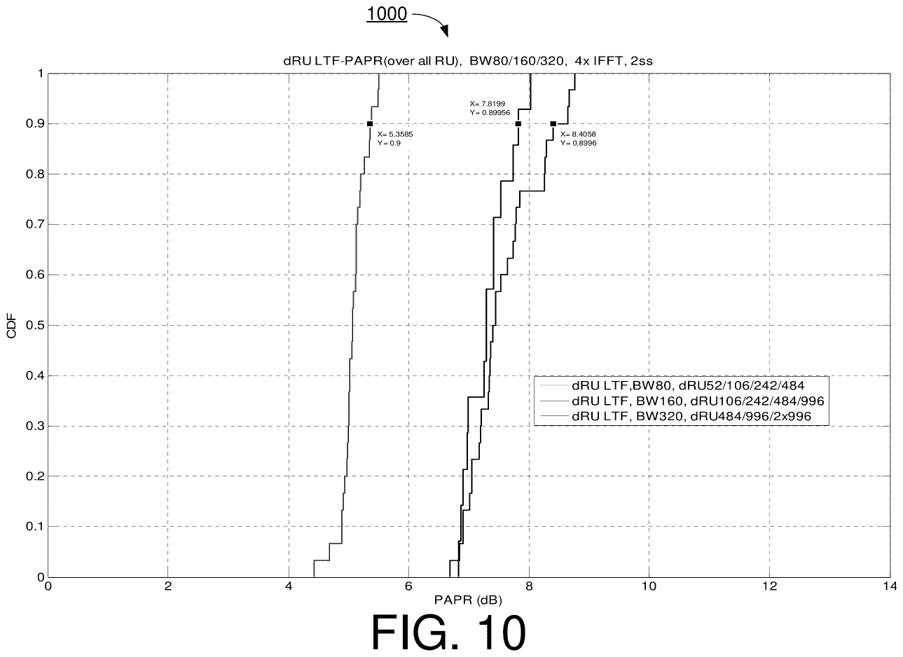

FIG. 10 illustrates an example scenario 1000 in accordance with an implementation of the present disclosure. Scenario 1000 may pertain to comparison of PAPR performances for DRU LTF for bandwidths of 80 MHz, 160 MHz and 320 MHz.

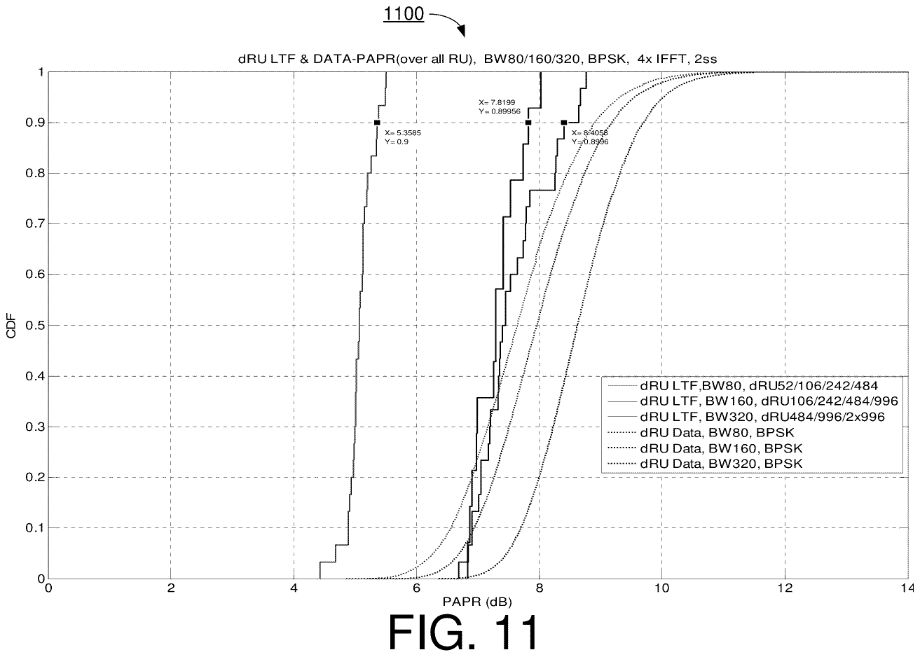

FIG. 11 illustrates an example scenario 1100 in accordance with an implementation of the present disclosure. Scenario 1100 may pertain to comparison of PAPR performances for DRU LTF for bandwidths of 80 MHz, 160 MHz and 320 MHz.

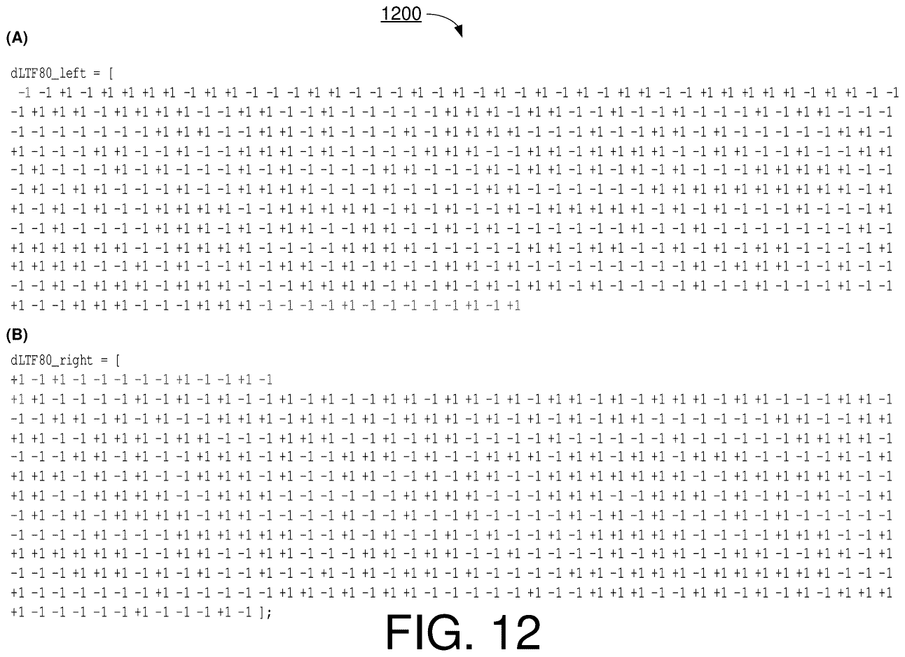

FIG. 12 illustrates an example design 1200 under a proposed scheme in accordance with the present disclosure. Design 1200 may pertain to a DRU LTF sequence design for wider bandwidths under a second option (Option-2). As shown in FIG. 12, each of the positions marked with “x” in FIG. 3 is replaced by +/−1 as a result of searching to minimize PAPR. According to design 1200, dLTF160=[C₁*dLTF80_left O₅, C₂*dLTF80_right O₂₃, C₃*dLTF80_left O₅, C₄*dLTF80_right], with C=[C₁ C₂ C₃ C₄]=[1 1 1 −1] which may be the same as that for an RRU LTF on 160 MHz.

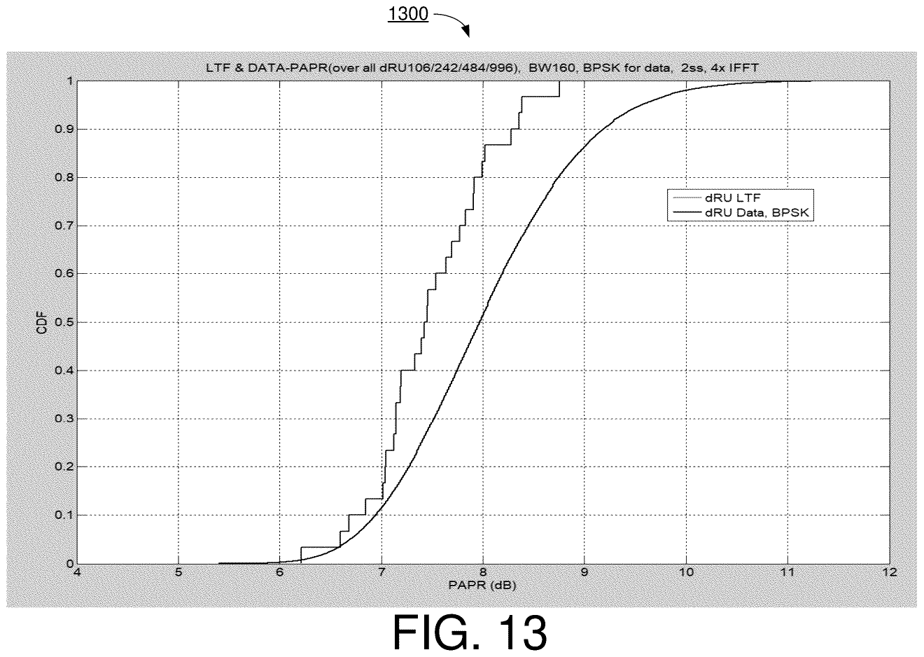

FIG. 13 illustrates an example scenario 1300 in accordance with an implementation of the present disclosure. Scenario 1300 may pertain to PAPR performance for DRU LTF for the wider bandwidth of 160 MHz under Option-2.

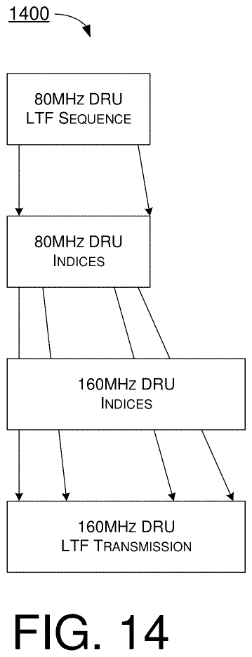

FIG. 14 illustrates an example design 1400 under a proposed scheme in accordance with the present disclosure. Design 1400 may pertain to DRU LTF transmission with a two-step process. Under the proposed scheme, a DRU LTF sequence for wider bandwidths may be generated by reusing an LTF sequence for 80 MHz DRUs, which is an 80 MHz DRU LTF base sequence. Notably, the 80 MHz DRU LTF base sequence may need to be modified for transmission of 996-tone DRUs. Some of “0” positions in the tone plan of dLTF80 may need to be replaced by +/−1 by searching and optimization to minimize PAPR. In the first step of the two-step process, 80 MHz DRU indices may be used to fetch a sub-sequence from dLTF80. In the second step of the two-step process, the fetched sub-sequence may be mapped to 160 MHz DRU LTF transmission based on corresponding 160 MHz DRU tone indices or subcarrier indices.

### Illustrative Implementations

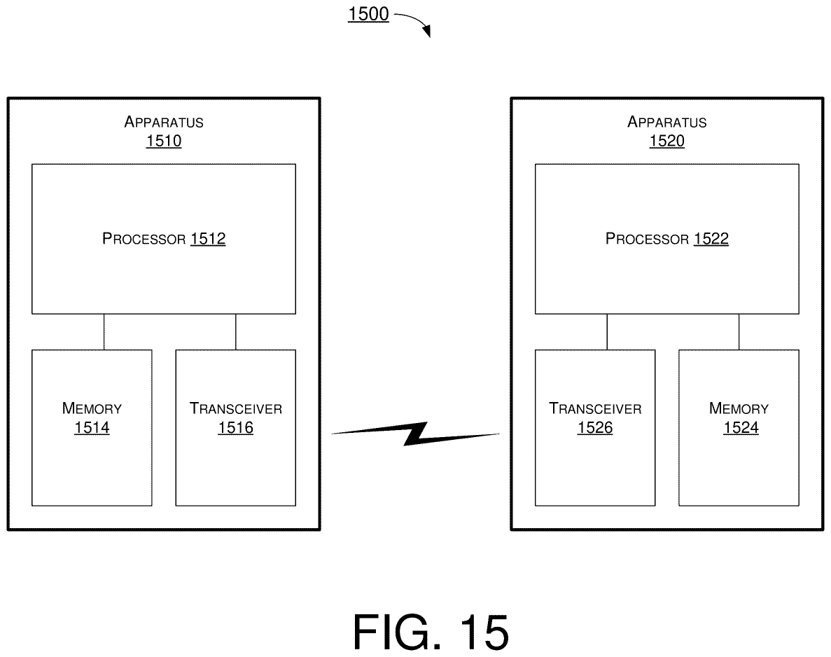

FIG. 15 illustrates an example system 1500 having at least an example apparatus 1510 and an example apparatus 1520 in accordance with an implementation of the present disclosure. Each of apparatus 1510 and apparatus 1520 may perform various functions to implement schemes, techniques, processes and methods described herein pertaining to LTF sequence design for DRUs on wider bandwidths in wireless communications, including the various schemes described above with respect to various proposed designs, concepts, schemes, systems and methods described above as well as processes described below. For instance, apparatus 1510 may be an example implementation of communication entity 110, and apparatus 1520 may be an example implementation of communication entity 120.

Each of apparatus 1510 and apparatus 1520 may be a part of an electronic apparatus, which may be a STA or an AP, such as a portable or mobile apparatus, a wearable apparatus, a wireless communication apparatus or a computing apparatus. For instance, each of apparatus 1510 and apparatus 1520 may be implemented in a smartphone, a smart watch, a personal digital assistant, a digital camera, or a computing equipment such as a tablet computer, a laptop computer or a notebook computer. Each of apparatus 1510 and apparatus 1520 may also be a part of a machine type apparatus, which may be an IoT apparatus such as an immobile or a stationary apparatus, a home apparatus, a wire communication apparatus or a computing apparatus. For instance, each of apparatus 1510 and apparatus 1520 may be implemented in a smart thermostat, a smart fridge, a smart door lock, a wireless speaker or a home control center. When implemented in or as a network apparatus, apparatus 1510 and/or apparatus 1520 may be implemented in a network node, such as an AP in a WLAN.

In some implementations, each of apparatus 1510 and apparatus 1520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1510 and apparatus 1520 may be implemented in or as a STA or an AP. Each of apparatus 1510 and apparatus 1520 may include at least some of those components shown in FIG. 15 such as a processor 1512 and a processor 1522, respectively, for example. Each of apparatus 1510 and apparatus 1520 may further include one or more other components not pertinent to the proposed scheme of the present disclosure (e.g., internal power supply, display device and/or user interface device), and, thus, such component(s) of apparatus 1510 and apparatus 1520 are neither shown in FIG. 15 nor described below in the interest of simplicity and brevity.

In one aspect, each of processor 1512 and processor 1522 may be implemented in the form of one or more single-core processors, one or more multi-core processors, one or more RISC processors or one or more CISC processors. That is, even though a singular term “a processor” is used herein to refer to processor 1512 and processor 1522, each of processor 1512 and processor 1522 may include multiple processors in some implementations and a single processor in other implementations in accordance with the present disclosure. In another aspect, each of processor 1512 and processor 1522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1512 and processor 1522 is a special-purpose machine specifically designed, arranged and configured to perform specific tasks including those pertaining to LTF sequence design for DRUs on wider bandwidths in wireless communications in accordance with various implementations of the present disclosure. For instance, each of processor 1512 and processor 1522 may be configured with hardware components, or circuitry, implementing one, some or all of the examples described and illustrated herein.

In some implementations, apparatus 1510 may also include a transceiver 1516 coupled to processor 1512. Transceiver 1516 may be capable of wirelessly transmitting and receiving data. In some implementations, apparatus 1520 may also include a transceiver 1526 coupled to processor 1522. Transceiver 1526 may include a transceiver capable of wirelessly transmitting and receiving data.

In some implementations, apparatus 1510 may further include a memory 1514 coupled to processor 1512 and capable of being accessed by processor 1512 and storing data therein. In some implementations, apparatus 1520 may further include a memory 1524 coupled to processor 1522 and capable of being accessed by processor 1522 and storing data therein. Each of memory 1514 and memory 1524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1514 and memory 1524 may include a type of read-only memory (ROM) such as mask ROM, programmable ROM (PROM), erasable programmable ROM (EPROM) and/or electrically erasable programmable ROM (EEPROM). Alternatively, or additionally, each of memory 1514 and memory 1524 may include a type of non-volatile random-access memory (NVRAM) such as flash memory, solid-state memory, ferroelectric RAM (FeRAM), magnetoresistive RAM (MRAM) and/or phase-change memory.

Each of apparatus 1510 and apparatus 1520 may be a communication entity capable of communicating with each other using various proposed schemes in accordance with the present disclosure. For illustrative purposes and without limitation, a description of capabilities of apparatus 1510, as communication entity 110, and apparatus 1520, as communication entity 120, is provided below in the context of example process 1600. It is noteworthy that, although the example implementations described below are provided in the context of WLAN, the same may be implemented in other types of networks. Thus, although the following description of example implementations pertains to a scenario in which apparatus 1510 functions as a transmitting device and apparatus 1520 functions as a receiving device, the same is also applicable to another scenario in which apparatus 1510 functions as a receiving device and apparatus 1520 functions as a transmitting device.

### Illustrative Processes

FIG. 16 illustrates an example process 1600 in accordance with an implementation of the present disclosure. Process 1600 may represent an aspect of implementing various proposed designs, concepts, schemes, systems and methods described above. More specifically, process 1600 may represent an aspect of the proposed concepts and schemes pertaining to LTF sequence design for DRUs on wider bandwidths in wireless communications in accordance with the present disclosure. Process 1600 may include one or more operations, actions, or functions as illustrated by one or more of blocks 1610 and 1620. Although illustrated as discrete blocks, various blocks of process 1600 may be divided into additional blocks, combined into fewer blocks, or eliminated, depending on the desired implementation. Moreover, the blocks/sub-blocks of process 1600 may be executed in the order shown in FIG. 16 or, alternatively, in a different order. Furthermore, one or more of the blocks/sub-blocks of process 1600 may be executed repeatedly or iteratively. Process 1600 may be implemented by or in apparatus 1510 and apparatus 1520 as well as any variations thereof. Solely for illustrative purposes and without limiting the scope, process 1600 is described below in the context of apparatus 1510 as communication entity 110 (e.g., a transmitting device whether a STA or an AP) and apparatus 1520 as communication entity 120 (e.g., a receiving device whether a STA or an AP) of a wireless network such as a WLAN in accordance with one or more of IEEE 802.11 standards. Process 1600 may begin at block 1610.

At 1610, process 1600 may involve processor 1512 of apparatus 1510 generating an LTF of a DRU using a predefined DRU LTF base sequence. Process 1600 may proceed from 1610 to 1620.

At 1620, process 1600 may involve processor 1512 transmitting, via transceiver 1516, the LTF sequence in a wireless communication (e.g., with apparatus 1520) over a bandwidth of 160 MHz or wider.

In some implementations, the predefined LTF base sequence may include an IEEE 802.11bn 80 MHz DRU LTF base sequence. In some implementations, in generating the DRU LTF sequence, process 1600 may involve processor 1512 changing a value of each of some of a plurality of positions in the IEEE 802.11bn 80 MHz DRU LTF base sequence from 0 to −1 or +1.

In some implementations, in generating the DRU LTF sequence, process 1600 may involve processor 1512 generating a DRU LTF sequence for 160 MHz (dLTF160). In such cases, dLTF160=[C₁*dLTF80_left O₅, C₂*dLTF80_right O₂₃, C₃*dLTF80_left O₅, C₄*dLTF80_right]. Here, dLTF80_left denotes a left half of an LTF sequence for 80 MHz DRUs; dLTF80_right denotes a right half of the LTF sequence for 80 MHz DRUs; a value of each of coefficients C₁, C₂, C₃, C₄ is −1 or +1; 0₅ denotes five consecutive 0s; and 0₂₃ denotes twenty-three consecutive 0s. In some implementations, a vector C=[C₁ C₂ C₃ C₄]=[1 1 1 −1].

In some implementations, in generating the DRU LTF sequence, process 1600 may involve processor 1512 generating a DRU LTF sequence for 320 MHz (dLTF320). In such cases, dLTF320=[C₁*dLTF80_left O₅, C₂*dLTF80_right O₂₃, C₃*dLTF80_left O₅, C₄*dLTF80_right O₂₃, C₅*dLTF80_left O₅, C₆*dLTF80_right O23, C₇*dLTF80_left O₅, C₈*dLTF80_right]. Here, dLTF80_left denotes a left half of an LTF sequence for 80 MHz DRUs; dLTF80_right denotes a right half of the LTF sequence for 80 MHz DRUs; a value of each of coefficients C₁, C₂, C₃, C₄, C₅, C₆, C₇, C₈ is −1 or +1; 0₅ denotes five consecutive 0s; and 0₂₃ denotes twenty-three consecutive 0s. In some implementations, a vector C=[C₁ C₂ C₃ C₄ C₅ C₆ C₇ C₈]=[1 1 −1 −1 1 −1 −1].

In some implementations, in generating the DRU LTF sequence, process 1600 may involve processor 1512 generating a DRU LTF sequence for 240 MHz (dLTF240). In such cases, dLTF240=[C₁*dLTF80_left O₅, C₂*dLTF80_right O₂₃, C₃*dLTF80_left O₅, C₄*dLTF80_right O₂₃, C₅*dLTF80_left O₅, C₆*dLTF80_right]. Here, dLTF80_left denotes a left half of an LTF sequence for 80 MHz DRUs; dLTF80_right denotes a right half of the LTF sequence for 80 MHz DRUs; a value of each of coefficients C₁, C₂, C₃, C₄, C₅, C₆ is −1 or +1; 0₅ denotes five consecutive 0s; and 0₂₃ denotes twenty-three consecutive 0s.

In some implementations, in generating the DRU LTF sequence, process 1600 may involve processor 1512 generating a DRU LTF sequence for 480 MHz (dLTF480). In such cases, dLTF480=[C₁*dLTF80_left O₅, C₂*dLTF80_right O₂₃, C₃*dLTF80_left O₅, C₄*dLTF80_right, O₂₃, C₅*dLTF80_left O₅, C₆*dLTF80_right O₂₃, C₇*dLTF80_left O₅, C₈*dLTF80_right O₂₃, C₉*dLTF80_left O₅, C₁₀*dLTF80_right O₂₃, C₁₁*dLTF80_left O₅, C₁₂*dLTF80_right]. Here, dLTF80_left denotes a left half of an LTF sequence for 80 MHz DRUs; dLTF80_right denotes a right half of the LTF sequence for 80 MHz DRUs; a value of each of coefficients C₁, C₂, C₃, C₄, C₅, C₆, C₇, C₈, C₉, C₁₀, C₁₁, C₁₂ is −1 or +1; 0₅ denotes five consecutive 0s; and 0₂₃ denotes twenty-three consecutive 0s.

In some implementations, in generating the DRU LTF sequence, process 1600 may involve processor 1512 generating a DRU LTF sequence for the bandwidth of 160 MHz or wider with a two-step process by reusing an 80 MHz DRU LTF base sequence (dLTF80) such that: (1) a value of each of some of a plurality of positions in the dLTF80 is changed from 0 to −1 or +1; (2) a sub-sequence from the dLTF80 is fetched using 80 MHz DRU indices; and (3) the sub-sequence is mapped to a DRU LTF transmission over the bandwidth of 160 MHz or wider based on corresponding DRU tone indices or subcarrier indices.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a long-training field (LTF) sequence of a distributed-tone resource unit (DRU) using a predefined DRU LTF base sequence; and
transmitting, by the processor, the DRU LTF sequence in a wireless communication for an DRU over a bandwidth of 160 MHz or wider.

2. The method of claim 1, wherein the predefined DRU LTF base sequence comprises an Institute of Electrical and Electronics Engineers (IEEE) 802.11bn 80 MHz DRU LTF base sequence.

3. The method of claim 2, wherein the generating of the DRU LTF sequence comprises changing a value of each of some of a plurality of positions in the IEEE 802.11bn 80 MHz DRU LTF base sequence from 0 to −1 or +1.

4. The method of claim 1, wherein the generating of the DRU LTF sequence comprises generating a DRU LTF sequence for 160 MHz (dLTF160), and wherein:
$$dLTF 160 = [ {C}_{1} * dLTF80\_left {O}_{5} , {C}_{2} * dLTF80\_right {O}_{23} , {C}_{3} * dLTF80\_left {O}_{5} , {C}_{4} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄ is −1 or +1;
0₅ denotes five consecutive 0s; and
0₂₃ denotes twenty-three consecutive 0s.

5. The method of claim 4, wherein a vector C=[C₁ C₂ C₃ C₄]=[1 1 1 −1].

6. The method of claim 1, wherein the generating of the DRU LTF sequence comprises generating a DRU LTF sequence for 320 MHz (dLTF320), and wherein:
$$dLTF 320 = [ {C}_{1} * dLTF80\_left {O}_{5} , {C}_{2} * dLTF80\_right {O}_{23} , {C}_{3} * dLTF80\_left {O}_{5} , {C}_{4} * dLTF80\_right O 23 , {C}_{5} * dLTF80\_left {O}_{5} , {C}_{6} * dLTF80\_right {O}_{23} , {C}_{7} * dLTF80\_left {O}_{5} , {C}_{8} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄, C₅, C₆, C₇, C₈ is −1 or +1;
0₅ denotes five consecutive 0s; and
0₂₃ denotes twenty-three consecutive 0s.

7. The method of claim 6, wherein a vector C=[C₁ C₂ C₃ C₄ C₅ C₆ C₇ C₈]=[1 1 −1 −1 1 −1 1 −1].

8. The method of claim 1, wherein the generating of the DRU LTF sequence comprises generating a DRU LTF sequence for 240 MHz (dLTF240), and wherein:
$$dLT 240 = [ {C}_{1} * dLTF80\_left {O}_{5} , {C}_{2} * dLTF80\_right {O}_{23} , {C}_{3} * dLTF80\_left {O}_{5} , {C}_{4} * dLTF80\_right O 23 , {C}_{5} * dLTF80\_left {O}_{5} , {C}_{6} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄, C₅, C₆ is −1 or +1;
0₅ denotes five consecutive 0s; and
0₂₃ denotes twenty-three consecutive 0s.

9. The method of claim 1, wherein the generating of the DRU LTF sequence comprises generating a DRU LTF sequence for 480 MHz (dLTF480), and wherein:
$$dLTF 480 = [ {C}_{1} * dLTF80\_left {O}_{5} , {C}_{2} * dLTF80\_right {O}_{23} , {C}_{3} * dLTF80\_left {O}_{5} , {C}_{4} * dLTF80\_right , O 23 , {C}_{5} * dLTF80\_left {O}_{5} , {C}_{6} * dLTF80\_right {O}_{23} , {C}_{7} * dLTF80\_left {O}_{5} , {C}_{8} * dLTF80\_right O 23 , {C}_{9} * dLTF80\_left {O}_{5} , {C}_{10} * dLTF80\_right {O}_{23} , {C}_{11} * dLTF80\_left {O}_{5} , {C}_{12} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄, C₅, C₆, C₇, C₈, C₉, C₁₀, C₁₁, C₁₂ is −1 or +1;
0₅ denotes five consecutive 0s; and
0₂₃ denotes twenty-three consecutive 0s.

10. The method of claim 1, wherein the generating of the DRU LTF sequence comprises generating a DRU LTF sequence for the bandwidth of 160 MHz or wider with a two-step process by reusing an 80 MHz DRU LTF base sequence (dLTF80) such that:
a value of each of some of a plurality of positions in the dLTF80 is changed from 0 to −1 or +1;
a sub-sequence from the dLTF80 is fetched using 80 MHz DRU indices; and
the sub-sequence is mapped to a DRU LTF transmission over the bandwidth of 160 MHz or wider based on corresponding DRU tone indices or subcarrier indices.

11. An apparatus, comprising:
a transceiver configured to transmit and receive wirelessly; and
a processor coupled to the transceiver and configured to perform operations comprising:
generating a long-training field (LTF) sequence of a distributed-tone resource unit (DRU) using a predefined DRU LTF base sequence; and
transmitting, via the transceiver, the DRU LTF sequence in a wireless communication for an DRU over a bandwidth of 160 MHz or wider.

12. The apparatus of claim 11, wherein the predefined DRU LTF base sequence comprises an Institute of Electrical and Electronics Engineers (IEEE) 802.11bn 80 MHz DRU LTF base sequence.

13. The apparatus of claim 12, wherein the generating of the DRU LTF sequence comprises changing a value of each of some of a plurality of positions in the IEEE 802.11bn 80 MHz DRU LTF base sequence from 0 to −1 or +1.

14. The apparatus of claim 11, wherein the generating of the DRU LTF sequence comprises generating a DRU LTF sequence for 160 MHz (dLTF160), and wherein:
$$dLTF 160 = [ {C}_{1} * dLTF80\_left {O}_{5} , {C}_{2} * dLTF80\_right {O}_{23} , {C}_{3} * dLTF80\_left {O}_{5} , {C}_{{4}^{*}} dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄ is −1 or +1;
0₅ denotes five consecutive 0s; and
0₂₃ denotes twenty-three consecutive 0s.

15. The apparatus of claim 14, wherein a vector C=[C₁ C₂ C₃ C₄]=[1 1 1 −1].

16. The apparatus of claim 11, wherein the generating of the DRU LTF sequence comprises generating a DRU LTF sequence for 320 MHz (dLTF320), and wherein:
$$dLTF 320 = [ {C}_{1} * dLTF80\_left {O}_{5} , {C}_{2} * dLTF80\_right {O}_{23} , {C}_{3} * dLTF80\_left {O}_{5} , {C}_{{4}^{*}} dLTF80\_right O 23 , {C}_{5} dLTF80\_left {O}_{5} , {C}_{6} * dLTF80\_right {O}_{23} , {C}_{7} * dLTF80\_left {O}_{5} , {C}_{8} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄, C₅, C₆, C₇, C₈ is −1 or +1;
0₅ denotes five consecutive 0s; and
0₂₃ denotes twenty-three consecutive 0s.

17. The apparatus of claim 16, wherein a vector C=[C₁ C₂ C₃ C₄ C₅ C₆ C₇ C₈]=[1 1 −1 −1 1 −1 1 −1].

18. The apparatus of claim 11, wherein the generating of the DRU LTF sequence comprises generating a DRU LTF sequence for 240 MHz (dLTF240), and wherein:
$$dLT F 240 = [ {C}_{1} * dLTF80\_left {O}_{5} , {C}_{2} * dLTF80\_right {O}_{23} , {C}_{3} * dLTF80\_left {O}_{5} , {C}_{4} * dLTF80\_right O 23 , {C}_{5} * dLTF80\_left {O}_{5} , {C}_{6} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄, C₅, C₆ is −1 or +1;
0₅ denotes five consecutive 0s; and
0₂₃ denotes twenty-three consecutive 0s.

19. The apparatus of claim 11, wherein the generating of the DRU LTF sequence comprises generating a DRU LTF sequence for 480 MHz (dLTF480), and wherein:
$$dLTF 480 = [ {C}_{1} * dLTF80\_left {O}_{5} , {C}_{2} * dLTF80\_right {O}_{23} , {C}_{3} * dLTF80\_left {O}_{5} , {C}_{{4}^{*}} dLTF80\_right , O 23 , {C}_{5} * dLTF80\_left {O}_{5} , {C}_{6} * dLTF80\_right {O}_{23} , {C}_{7} * dLTF80\_left {O}_{5} , {C}_{{8}^{*}} dLTF80\_right O 23 , {C}_{{9}^{*}} dLTF80\_left {O}_{5} , {C}_{10} * dLTF80\_right {O}_{23} , {C}_{11} * dLTF80\_left {O}_{5} , {C}_{12} * dLTF80\_right ] ;$$
dLTF80_left denotes a left half of an LTF sequence for 80 MHz DRUs;
dLTF80_right denotes a right half of the LTF sequence for 80 MHz DRUs;
a value of each of coefficients C₁, C₂, C₃, C₄, C₅, C₆, C₇, C₈, C₉, C₁₀, C₁₁, C₁₂ is −1 or +1;
0₅ denotes five consecutive 0s; and
0₂₃ denotes twenty-three consecutive 0s.

20. The apparatus of claim 11, wherein the generating of the DRU LTF sequence comprises generating a DRU LTF sequence for the bandwidth of 160 MHz or wider with a two-step process by reusing an 80 MHz DRU LTF base sequence (dLTF80) such that:
a value of each of some of a plurality of positions in the dLTF80 is changed from 0 to −1 or +1;
a sub-sequence from the dLTF80 is fetched using 80 MHz DRU indices; and
the sub-sequence is mapped to a DRU LTF transmission over the bandwidth of 160 MHz or wider based on corresponding DRU tone indices or subcarrier indices.
